(19) United States
(12) Patent Application Publication
(10) Pub. No.: US 2024/0313962 A1
(43) Pub. Date: Sep. 19, 2024

(54) Security Controller and Method for Performing a Selection Function

(71) Applicant: Infineon Technologies AG, Neubiberg (DE)

(72) Inventors: Martin Schläffer, Zell am See (DE); Florian Mendel, Munchen (DE)

(21) Appl. No.: 18/602,658

(22) Filed: Mar. 12, 2024

(30) Foreign Application Priority Data
Mar. 13, 2023 (DE) 102023106166.6

(51) Int. Cl. H04L 9/08

(52) U.S. Cl. CPC H04L 9/088

(57) ABSTRACT

According to various embodiments, a security controller is configured to decompose a selection value into at least a first share and a second share, wherein the selection value indicates which of two selection function input values should be selected. The security controller comprises a processor configured to execute a first operation to generate a first result depending on the first share, execute a second operation to generate a second result depending on the second share and execute a third operation which processes the first result and the result in such a way that the execution of the first operation, the second operation and the third operation implement a selection function which combines the selection function input values with the selection value such that the combination results in the one of the selection function input values for which the selection value indicates that it is to be selected.

### TECHNICAL FIELD

The present disclosure relates to security controllers and methods for performing a selection function.

### BACKGROUND

Electronic devices which process secure data, such as cryptographic keys, should be protected against attacks like fault attacks and side-channel analysis. One approach to counter attacks is the introduction of dummy calculations which are introduced in a processing flow. In such an approach, a control signal indicates whether an operation is a dummy operation or a “real” operation (i.e. whether a dummy operation or a real operation is selected). However, a SIFA (Statistical Ineffective Fault Attack) may allow an attacker to gain information about the control signal of this selection, making such a counter measure ineffective. Therefore, approaches are desirable which protect a security measure based on dummy operations against SIFA.

### SUMMARY

According to various embodiments, a security controller is configured to decompose a selection value into at least a first share and a second share, wherein the selection value indicates which of two selection function input values should be selected According to at least some of these embodiments, the security controller includes a processor configured to:
execute a first operation to generate a first operation result, wherein the first operation receives as input the first share and a first operation input value which depends on at least one of the selection function input values,
execute a second operation to generate a second operation result, wherein the second operation receives as input the second share and a second operation input value which depends on at least one of the selection function input values, and
execute a third operation which processes the first operation result and the second operation result in such a way that the execution of the first operation, the second operation and the third operation implement a selection function which combines the selection function input values with the selection value such that the combination results in the one of the selection function input values for which the selection value indicates that it is to be selected.

### BRIEF DESCRIPTION OF THE FIGURES

In the drawings, similar reference characters generally refer to the same parts throughout the different views. The drawings are not necessarily to scale, emphasis instead generally being placed upon illustrating the principles of the invention. In the following description, various aspects are described with reference to the following drawings, in which:

FIG. 1 shows an example for a processing device.

FIG. 2 shows a processing circuit according to an embodiment.

FIG. 3 shows an AND gate.

FIG. 4 illustrates a SIFA (Statistical Ineffective Fault Attack) on an AND gate.

FIG. 5 shows a masked AND gate in comparison to an AND gate.

FIG. 6 illustrates a SIFA in a context of a processing circuit like illustrated in FIG. 2.

FIG. 7 illustrates a processing device with redundant computations.

FIG. 8 shows a security controller according to an embodiment.

FIG. 9 shows a flow diagram illustrating a method for performing a selection function according to an embodiment.

### DETAILED DESCRIPTION

The following detailed description refers to the accompanying drawings that show, by way of illustration, specific details and aspects of this disclosure in which the invention may be practiced. Other aspects may be utilized and structural, logical, and electrical changes may be made without departing from the scope of the invention. The various aspects of this disclosure are not necessarily mutually exclusive, as some aspects of this disclosure can be combined with one or more other aspects of this disclosure to form new aspects.

The embodiments described herein can be realized by a processing device like a personal computer, microcontroller, smart card (of any form factor), secure microcontroller, hardware root of trust, (embedded) secure element (ESE), Trusted Platform Module (TPM), or Hardware Security Module (HSM).

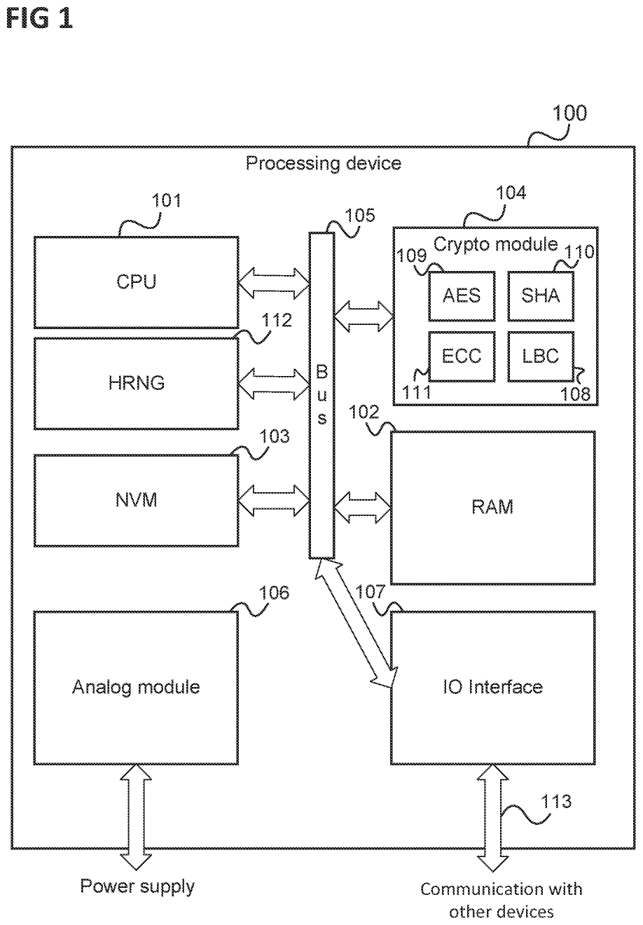

FIG. 1 shows an example for a processing device (e.g. a security controller circuit) 100 including a CPU 101, a RAM 102, a non-volatile memory 103 (NVM), a crypto module 104, an analog module 106, an input/output interface 107 and a hardware-random number generator 112.

In this example, the CPU 101 has access to at least one crypto module 104 over a shared bus 105 to which each crypto module 104 is coupled. Each crypto module 104 may in particular include one or more crypto cores to perform certain cryptographic operations. Exemplary crypto cores are:
an AES core 109,
a SHA core 110,
an ECC core 111, and
a lattice-based crypto (LBC) core 108.

The lattice-based crypto core 108 may be provided in order to accelerate lattice-based cryptography.

The CPU 101, the hardware random number generator 112, the NVM 103, the crypto module 104, the RAM 102 and the input/output interface 107 are connected to the bus 105. The input output interface 107 may have a connection 113 to other devices, which may be similar to the processing device 100.

The analog module 106 is supplied with electrical power via an electrical contact and/or via an electromagnetic field. This power is supplied to drive the circuitry of the processing device 100 and may in particular allow the input/output interface to initiate and/or maintain connections to other devices via the connection 113.

The bus 105 itself may be masked or plain. Instructions for carrying out the processing and algorithms described in the following may in particular be stored in the NVM 103 and processed by the CPU 105. The data processed may be stored in the NVM 103 or in the RAM 102. Supporting functions may be provided by the crypto modules 104 (e.g., expansion of pseudo random data). Random numbers are supplied by the hardware-random number generator 112.

To perform the procedures described in the following, instructions may be stored in the crypto module 104 or they may be provided by the CPU 101 via the bus 105. Data may be stored locally within the crypto module 104. It is also an option that the data is temporarily stored in the RAM 102 or the NVM 103.

The processing and algorithms described in the following may exclusively or at least partially be conducted on the crypto module 104 or on the CPU 101. A processing circuit (such as crypto module 104 or CPU 101) may or may not be equipped with hardware-based security features. Such hardware-based security features could be circuits that implement countermeasures against side-channel power analysis or fault injection (e.g., using a laser), to avoid that an attacker gains information about secret data (such as cryptographic keys or secret user data). Such countermeasures may be realized by the use of randomness, redundant hardware, or redundant processing. In general, the goal of countermeasures is to disguise the internally processed values from an attacker who is able to observe the physical effect the processing of such values.

Typical concepts for protecting the computation of secret data are randomizing the execution order of operations (hiding), performing dummy operations on dummy data (hiding) and masking data to perform randomized computations.

In the following, the usage of dummy operations is described in more detail.

The processing described in the following may be performed by a processing circuit like CPU 101 or crypto module 104 (e.g. a crypto core). When reference is made to a memory, this may for example be RAM 102 but also an NVM 103 or processor registers (or a combination of them). The memory may store a program (e.g. for performing a cryptographic method) having instructions to perform cryptographic operations (e.g. computations) and stores data in form of data words to be processed.

According to various embodiments, operations (e.g. all operations) are masked. This means that the one or more data words processed by an operation are each split into shares.

For example, an operation calculating a function F operates on a data word a. The input word a is split into two shares a₀ and a₁ according to an XOR combination, i.e. a=a₀\hat{ }a₁ (where \hat{ } denotes XOR). The splitting into shares is not limited to XOR. XOR is only an example and for example arithmetic (addition) based masking is also possible. Further, the processing circuit implements the operation such that the output word b=F(a) is also masked, i.e. b=b₀\hat{ }b₁. The data words are for example stored in memory in masked form, i.e. the shares are stored (e.g. a is stored as pair of data words a₀, a₁). A data word may be remasked. This means that the shares are recomputed (i.e. refreshed). For example, the pair a₀, a₁ is changed to a₀′, a₁′ where a₀ \hat{ }a1=a₀′\hat{ }a₁′. This is referred to as refreshing or remasking operation (or computation) and can be done by XOR-combination of a₀ and a₁ both with a random value (referred to as mask refresh value) r, i.e. a₀′=a₀ \hat{ }rand a₁′=a₁\hat{ }r.

The processing circuit may use a randomized execution order for the operation (as far as this is possible). Further, according to various embodiments, the processing circuit introduces dummy phases during which it performs dummy operations (D) in between the phases where it performs real operations (R). For example, an operation sequence may be D-D-R-R-D-D. In the following, it is assumed that for each operation of a sequence of operations, a signal S indicates whether the operation is a dummy operation or not, i.e. there is a control sequence which specifies, for each operation is a dummy operation or as a real operation.

One possible approach to implement dummy operations in a security context is that the processing circuit performs both a real operation and a refreshing operation (for a data word processed in the real operation) in parallel (e.g. at least partially during the same one or more processor clock cycles). The refreshing operation serves as dummy operation and a multiplexer (MUX) selects between the refreshing and the real operation i.e. selects which processing result is output (and stored in memory). For example, (b₀[i]\hat{ }b₁[i])=MUX((a₀[i]\hat{ }r, a₁[i]\hat{ }r), (F₀(a₀[i], a₁[i]), F₁(a₀[i], a₁[i]))

Here, i may be a random positive integer to randomize the execution order.

An example is described in more detail in the following.

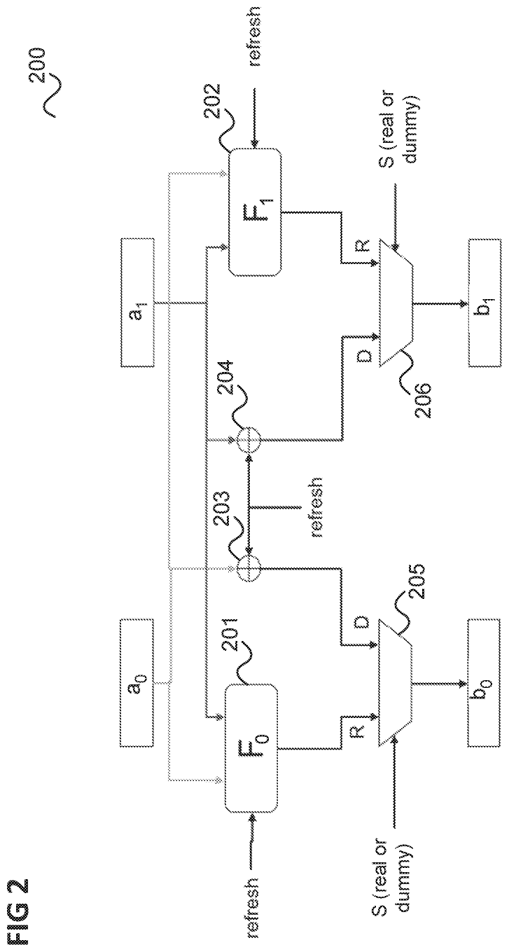

FIG. 2 shows a processing circuit 200 according to an embodiment.

The processing circuit 200 includes several (in this example two) parallel processing blocks (e.g. circuitry) 201, 202 for calculation of the output value of a function F of an input value.

As above, the input word is denoted as a, (randomly) split into shares a₀, a₁ and the output word is denoted as b, (randomly) split into shares b₀ and b₁.

The processing blocks 201, 202 calculate F₀(a₀, a₁) and F₁(a₀, a₁), respectively.

The processing circuit 200 further includes mask refresh circuits 203, 204. The mask refresh circuits 203, 204 receive a mask refresh value r and compute a₀′=a₀ \hat{ }r and a₁′=a₁ \hat{ }r, respectively.

A first multiplexer 205 receives the outputs of the first processing block 201 and the first mask refresh circuit 203. It receives a control value S which indicates whether a real operation should be carried out (i.e. F₀(a₀, a₁) should be output) or a dummy operation should be carried out (i.e. a₀′ should be output). Accordingly, the first multiplexer 205 outputs b₀=F₀(a₀, a₁) or b₀=a₀′ depending on the control value S.

Similarly, a second multiplexer 206 receives the outputs of the second processing block 202 and the second mask refresh circuit 204. It receives the control value which indicates whether a real operation should be carried out (i.e. F₁(a₀, a₁) should be output) or a dummy operation should be carried out (i.e. a₁′ should be output). Accordingly, the second multiplexer 206 outputs b₁=F₁(a₀, a₁) or b₁=a₁′ depending on the control value.

The control value may be a control value of a (random) sequence of control values (i.e. a control sequence). The control sequence thus specifies a sequence of real operations and dummy operations. Together with the value i the control sequence thus specifies an operation sequence. A resulting operation sequence may for example be D[2]-D[3]-D[0]-R[3]-R[0]-R[1]-R[2]-D[1].

The processing circuit 200 stores the output shares b₀, b₁ in memory.

For a real operation b=F(a)=b₀\hat{ }b1=F₀(a₀, a₁) \hat{ }F₁(a₀, a₁).

For a dummy operation b=a₀‘\hat{ }a₁’.

The output shares b₀, b₁ may for example be stored in the location of the input shares a₀, a₁. Thus, in case of a dummy operation, the processing may continue in the usual fashion since the dummy operation has only performed a remasking.

The approach of FIG. 2 allows protection by means of dummy operations with little area overhead (because there is no need to store extra dummy data) and without the need to include dummy memory hidden in between real memory. Moreover, since the results of dummy operation are written back to memory, a dummy operation indistinguishable from a real operation.

However, so called statistical ineffective fault attacks (SIFAs) can be used to attack a hiding countermeasure like the usage of dummy operations as described with reference to FIG. 2. This is explained in the following.

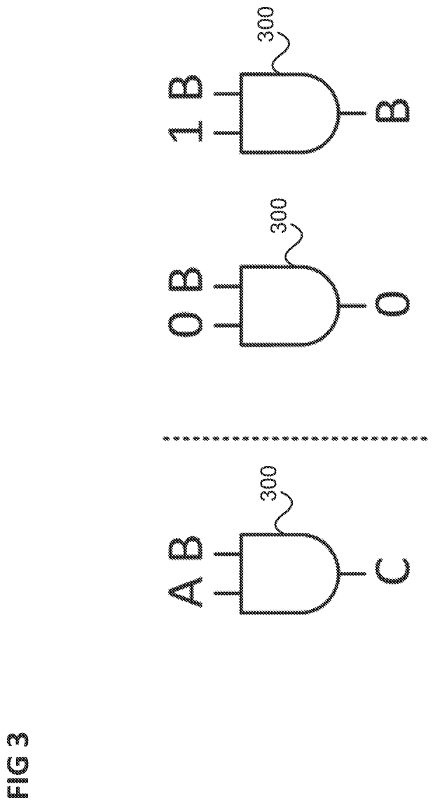

FIG. 3 shows an AND gate 300.

The AND gate's inputs are the bits A and B and its output is the bit C. Clearly, if A is 0 then the output C is 0 and if A is 1 then C is equal to B.

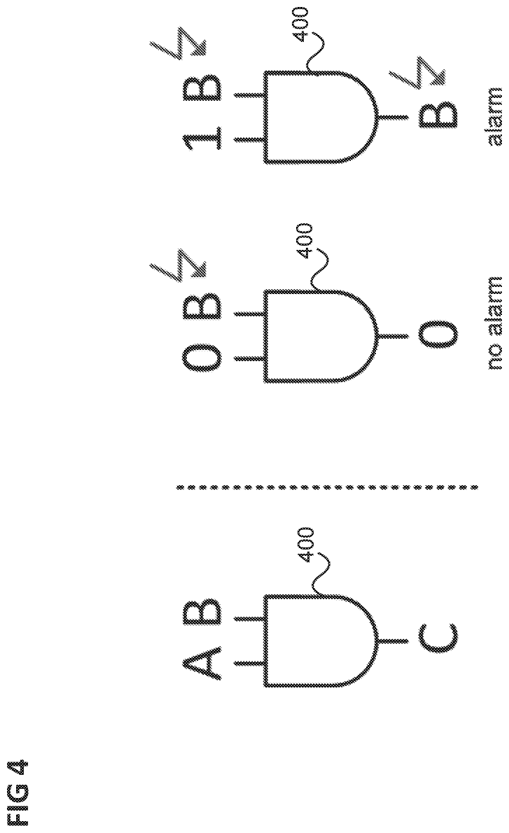

FIG. 4 illustrates a SIFA (Statistical Ineffective Fault Attack) on an AND gate 400.

As mentioned above, if A=0 then C=0. In particular, C does not depend on B while it does if A=1. So, if an attacker succeeds in manipulating B (i.e. changes B to NOT(B)) and this does not change C, A needs to be 0. Vice versa, if an attacker succeeds in manipulating B (i.e. changes B to NOT(B)) and this does change C, A needs to be 1.

Assuming that, for example, an alarm is triggered in the processing if the output C changes due to a manipulation of B (e.g. due to redundancy countermeasures) the attacker knows that when he manipulates B and there is an alarm that A=1 and otherwise A=0 with high probability (typically this probability is higher than 0.5 but not equal to 1 because the attacker cannot be perfectly sure that his manipulation attempt has really changed B to NOT(B)). The attacker can thus gain knowledge about A.

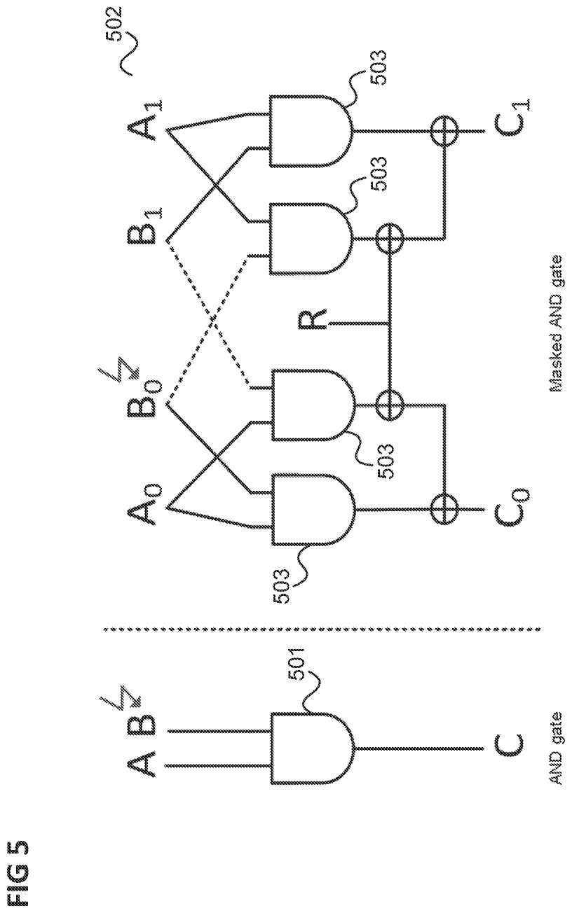

It should be noted that masking does not prevent that the attacker gains knowledge by such an attack as illustrated in FIG. 5.

FIG. 5 shows a masked AND gate 502 in comparison to an AND gate 501.

Here, the inputs A and B are each split into two shares A=A₀\hat{ }A₁ and B=B₀\hat{ }B₁ and there is a remasking (by a random bit R) at the output of the four AND gates 503 which form the masked AND gate 502. Still, it can for example be seen that if an attacker changes either B0 or B1 (and thus changes B=B0\hat{ }B1) and C=C0\hat{ }C1 does not change then A=A0\hat{ }A1 needs to be 0.

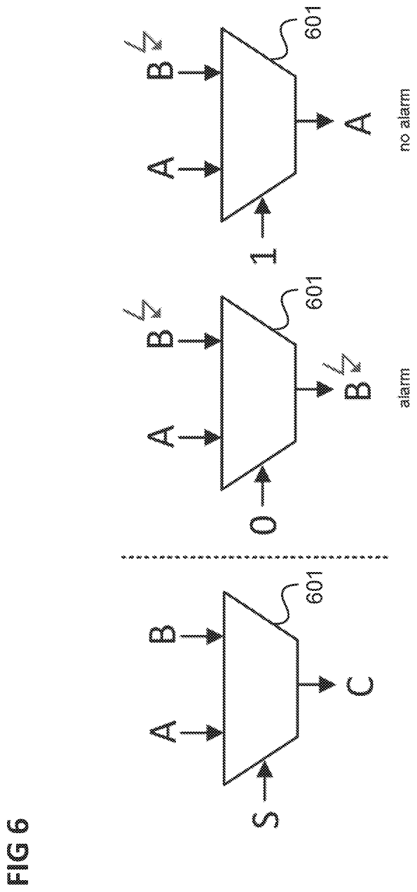

FIG. 6 illustrates a SIFA in a context of a processing circuit like illustrated in FIG. 2.

Assume that the multiplexer 601 shown in FIG. 6 corresponds to one of the multiplexers 205, 206 which receive a bit S and forward R (i.e. the result of the real operation) or D (i.e. the result of the dummy operation) depending on S. So, the multiplexer has a (data) input A (e.g. A=R) and a (data) input B (e.g. B=D), a (data) output C (e.g. C=b0 or C=b₁) and a control input S. It is assumed that for S=0, the multiplexer 601 is configured to output C=B and for S=1, the multiplexer 601 is configured to output C=A.

Now, similarly to what was described for the AND gate with reference to FIG. 4, if B is changed to NOT(B), A is kept unchanged and the output C does change, then S needs to be 0 while if the output C does not change, then S needs to be 1.

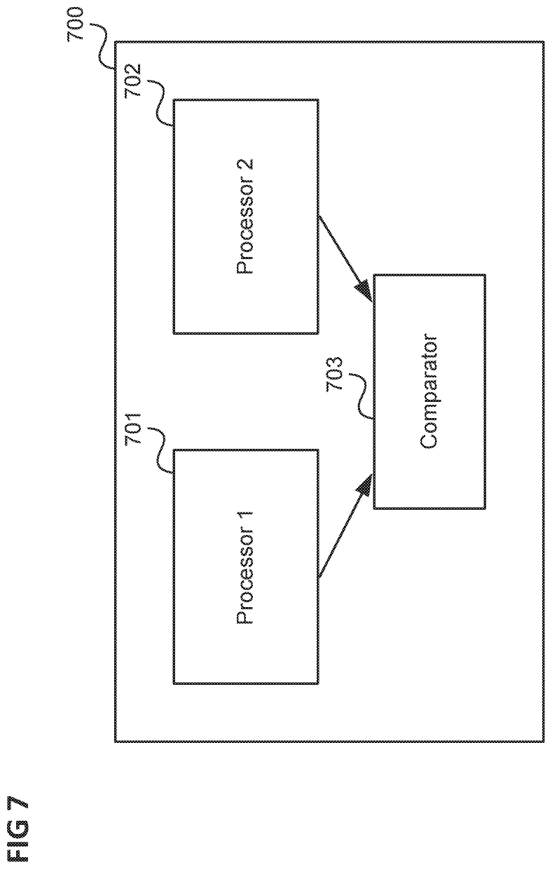

As above, the attacker may for example see whether C has changed from whether an alarm is triggered by his manipulation from redundancy (i.e. whether an alarm was triggered) as illustrated in FIG. 7.

FIG. 7 illustrates redundancy in a processing device, for example for safety reasons: two instances 701, 702 of a processing circuit are provided in a processing device 700 and the results of the two instances of the processing circuits 200 are compared by a comparator 703 which triggers an alarm in case the results of the two instances 701, 702 differ (e.g. for safety). Such a comparison may not only be provided for the results but also at other stages (i.e. for inputs or intermediate results).

So, if the two instances are instances of the processing circuit 200 and the attacker only manipulates B in one of the instances, he can thus determine from whether or not the comparator 703 triggers an alarm whether the manipulation had an impact on the output of the respective processing circuit 200. It should be noted that in particular this duplication of the processing circuit (e.g. duplication of a hardware circuit or a CPU) does not prevent that the attacker gains knowledge by a SIFA attack.

In case the multiplexer 601 is used as one of the multiplexers 205, 206, the attacker may thus gain knowledge about the value of S and thus about the sequence of dummy and real operations which makes the hiding mechanism of using dummy rounds and real rounds ineffective.

In the following, approaches are described which allow preventing that an attacker gains knowledge about a control signal S from an attack on a multiplexer 601 as illustrated in FIG. 6.

The following examples describes a multiplexer (MUX), which is implemented using a single AND (in software and/or hardware) i.e. the determination of C by the two operations

$$\begin{matrix}1. & \\ T = A ⋀ B & \end{matrix}$$

$$\begin{matrix}2. & \\ C = ( S \& T ) ⋀ A & \end{matrix}$$

This is in the following referred to as the multiplexer implementation using a single AND unprotected (single AND) implementation.

It should be noted that other implementations of a multiplexer are possible, e.g. an implementation using two AND according to

$$C = ( ! S \& A ) ⋀ ( S \& B )$$

A processing device 700 having duplicated CPU and/or hardware calculation circuits 701, 702 may for example check the values of A, B, C, S, T by comparison of, for each of these values, the respective values which are stored or determined in the two instances, e.g. stored in register files of both instances, i.e., as mentioned above, a comparison which triggers an alarm in case of a mismatch may not only be provided for the results C but also for the other values A, B, S and T.

Nevertheless, in the unprotected single AND implementation of a multiplexer, the weakness described above with reference to FIG. 6 is present: a fault in the second operation in T is not detected if S=0 by a comparison of the values for C of the two instances. Thus, a manipulation of T reveals information about S (i.e. whether a dummy or a real was carried out). It should be noted that to detect the manipulation by the redundancy (and comparison) mechanism, T would need to be compared directly before or inside the AND combination in operation 2 which is practically not possible.

In the following, multiplexer implementations that avoid this weakness of the multiplexer implementation using a single AND are given. So, it is in the following assumed that the control signal S is the secret and a fault (e.g. due to a manipulation of an attacker) should not leak information.

In the following approaches, the control signal S of the multiplexer is masked, i.e.

$$S = S 0 ⋀ S 1.$$

So, according to a first embodiment, the multiplexer output is calculated by the following five operations:

$$\begin{matrix}1 ) & \\ {S}_{0} = S ⋀ {S}_{1} & \end{matrix}$$

$$\begin{matrix}2 ) & \\ T = A ⋀ B & \end{matrix}$$

$$\begin{matrix}3 ) & \\ {C}_{0} = ( {S}_{0} \& T ) ⋀ A & \end{matrix}$$

$$\begin{matrix}4 ) & \\ {C}_{1} = {S}_{1} \& T & \end{matrix}$$

$$\begin{matrix}5 ) & \\ C = {C}_{0} ⋀ {C}_{1} & \end{matrix}$$

To gain knowledge on S, due to the masking of S (i.e. the splitting of into shares S₀ and S₁), the attacker needs to manipulate T two times (operation 3 and operation 4). Thus, the risk of a successful attack is reduced.

However, as indicated by the order of the arguments in S₀ & T and S₁ & T it is assumed that in the two operations 3 and 4, S₀ is provided at the same input terminal to an AND gate (or e.g. ALU in a software implementation) as S₁ and T is provided to the same input terminal (or ports) to an AND gate for operation 3 and operation 4.

So, to manipulate T, the attacker only needs to be able to manipulate at a single fault position (input terminal), i.e. the first embodiment is till susceptible to a single fault position.

To avoid this, the input terminals may be switched between operation 3 and operation 4 as in the following second embodiment:

$$\begin{matrix}1 ) & \\ {S}_{0} = S ⋀ {S}_{1} & \end{matrix}$$

$$\begin{matrix}2 ) & \\ T = A ⋀ B & \end{matrix}$$

$$\begin{matrix}3 ) & \\ {C}_{0} = ( {S}_{0} \& T ) ⋀ A & \end{matrix}$$

$$\begin{matrix}4 ) & \\ {C}_{1} = T \& {S}_{1} & \end{matrix}$$

$$\begin{matrix}5 ) & \\ C = {C}_{0} ⋀ {C}_{1} & \end{matrix}$$

Thus, more than one fault is needed (different position and different time) to learn about whether S=0 or S=1 (i.e. whether a real or a dummy round took place).

It should be noted that in the above embodiments, the values S, S0, S1, A, B, T, C0, C1 (and similarly the values in the processing circuit 200) are not necessarily single bits but may be multi-bit words (e.g. 4-bit words). All logical operations (AND, XOR etc.) may then be understood as bitwise operations.

For the following third embodiment, it is now assumed that each of the values is a multi-bit word. In that case, a value may in particular be rotated. For example, S₁>>>r is to be understood that the bits of S₁ are shifted to the right by r bit positions and the bits shifted out are shifted in from the left. The inverse operation is denoted as S₁<<<r.

In such a multi-bit implementation, an AND gate (in hardware) corresponds to an array of AND gates, wherein each AND gate processes (AND-combines) the bit values of a respective bit position of its inputs.

So, in the second embodiment, in the multi-bit case, for a specific bit position, the operations 3 and 4 are performed by the same AND gate. This means that the same AND gate AND-combines, for example, the third bit of S₀ with the third bit of T (for operation 3) as combines the third bit of S₁ with the third bit of T (for operation 4). So, an attacker only needs to be able to attack a single AND gate (albeit both input terminals of it due to the switch of orders from operation 3 to operation 4).

In view of this, to make it even harder for an attacker, a rotation (or any other permutation, wherein “permutation” means a bit permutation herein, i.e. a permutation of the bits of the respective value) is introduced such that the attacker needs to be capable to attack different AND gates in case of a hardware implementation.

Specifically, the third embodiment works as follows:
1) Two shares for the control signal are created by
   a. S1=random
      i.e. S₁ is determined based on random number generator output

$$\begin{matrix}b . & \\ {S}_{0} = S ⋀ ( {S}_{1} >>> r ) & \end{matrix}$$

i.e. the share S₁ of the control signal can be seen to be rotated:

$$S = S 0 ⋀ ( {S}_{1} >>> r )$$

$$\begin{matrix}2 ) & \\ {T}_{0} = A ⋀ B & \end{matrix}$$

$$\begin{matrix}3 ) & \\ {C}_{0} = ( {S}_{0} \& {T}_{0} ) ⋀ A & \end{matrix}$$

$$\begin{matrix}4 ) & \\ {T}_{1} = {T}_{0} << < r & \end{matrix}$$

$$\begin{matrix}5 ) & \\ {C}_{1} = {T}_{1} \& {S}_{1} & \end{matrix}$$

$$\begin{matrix}6 ) & \\ C = {C}_{0} ⋀ ( {C}_{1} >>> r ) & \end{matrix}$$

So, in summary:
First Embodiment:
   Not rotated, no port switch
   Same AND gate input terminals for T, S₀/S₁
Second Embodiment:
   Not rotated, with port switch
   Different positions for T, S0/S1
   But same AND gate (in hardware) for each bit position in operation 3 and operation 4 (because of no rotation)
Third embodiment
   rotated, with port switch
   with rotation (and thus different AND gates (in hardware) for each bit position in operation 3 and operation 4)
Fourth embodiment like third embodiment but any permutation (not necessarily rotation)

It should be noted that in the application of these three embodiments to the processing circuit 200, T is real data XORed with random (dummy data): A\hat{ }B. Faulting S₀ or S₁ does not leak information about T.

To learn information about S both T0 and T1 need to be faulted (two faults).

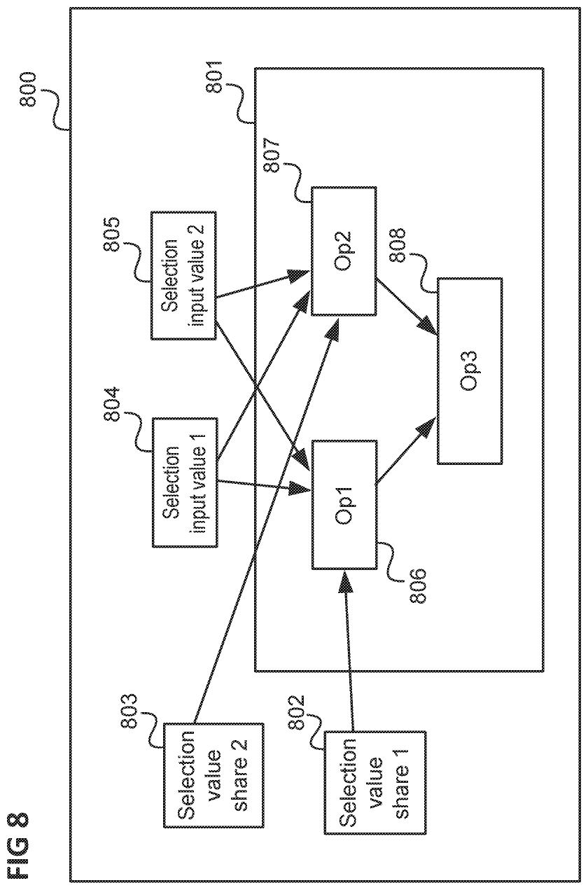

In summary, according to various embodiments, a security controller circuit is provided as illustrated in FIG. 8.

FIG. 8 shows a security controller circuit 800 according to an embodiment.

The security controller circuit 800 is configured to decompose a selection value into at least a first share 802 and a second share 803, wherein the selection value indicates which of two selection function input values 804, 805 should be selected.

Further, the security controller circuit 800 includes a processor circuit (e.g. a programmable processor) 801 configured to (e.g. by executing corresponding software)
execute a first operation 806 to generate a first operation result, wherein the first operation receives as input the first share 802 and a first operation input value which depends on at least one of the selection function input values 804, 805,
execute a second operation 807 to generate a second operation result, wherein the second operation receives as input the second share 803 and a second operation input value which depends on at least one of the selection function input values 804, 805,
execute a third operation 808 which processes the first operation result and the second operation result in such a way that the execution of the first operation, the second operation and the third operation implement a selection function which combines the selection function input values with the selection value such that the combination results in the one of the selection function input values for which the selection value indicates that it is to be selected.

According to various embodiments, in other words, a control value of a selection function is split into shares and both control value shares are independently (i.e. in two separate operations) combined with the selection function input values (i.e. each share with at least one of the input values). The result of the selection is then derived from these two combinations.

For example, the first operation corresponds to operation 3 in the above embodiments and the second operation corresponds to operation 4 in the first and the second embodiment and to operation 5 in the third embodiment and the third operation corresponds to the last operation in the above embodiments.

However, it should be noted that the operations may differ from the ones in the above embodiments. For example, an AND combination of two values may be simply replaced by the negation of the OR combination of the negated inputs. Further, other variants may be derived that give other forms to the operations than the ones in the above embodiments, e.g. according to the implementation with two ANDs C=(!S & A)\hat{ }(S & B) as mentioned above.

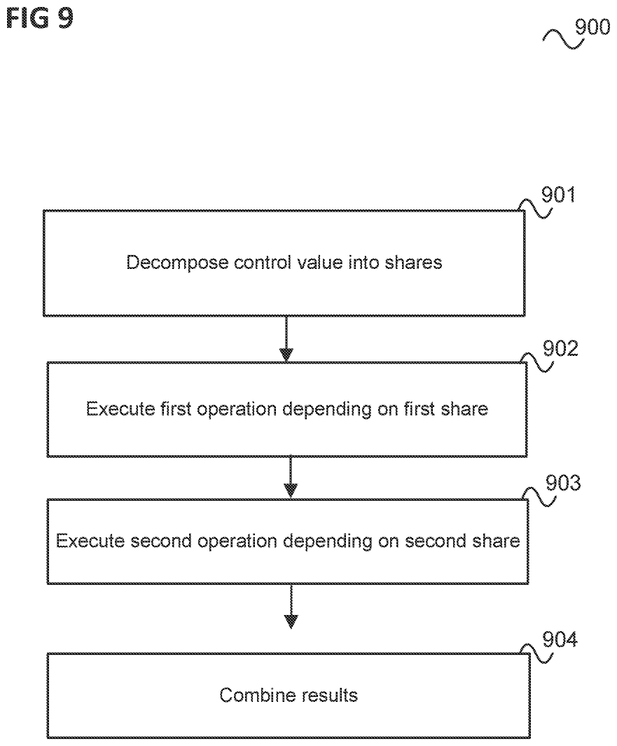

According to various embodiments, a method is performed as illustrated in FIG. 9.

FIG. 9 shows a flow diagram 900 illustrating a method for performing a selection function according to an embodiment.

In 901, a selection value is decomposed into at least a first share and a second share, wherein the selection value indicates which of two selection function input values should be selected.

In 902, a first operation is executed to generate a first operation result, wherein the first operation receives as input the first share and a first operation input value which depends on at least one of the selection function input values.

In 903, a second operation is executed to generate a second operation result, wherein the second operation receives as input the second share and a second operation input value which depends on at least one of the selection function input values.

In 904, a third operation is executed which processes the first operation result and the second operation result in such a way that the execution of the first operation, the second operation and the third operation implement a selection function which combines the selection function input values with the selection value such that the combination results in the one of the selection function input values for which the selection value indicates that it is to be selected.

Various Examples are described in the following:

Example 1 is a security controller as described above with reference to FIG. 8.

Example 2 is a security controller of example 1, wherein the processor is configured to calculate a first result based on the first operation result, the second operation result and/or the result of the third operation, and the data processing device includes a further processor configured to calculate a second result by applying the selection function to the first selection function input value and the second selection function input value (i.e. e.g. also executes the first operation, second operation and third operation), and wherein the data processing device is configured to check whether the first result and the second result match and, if the first result and the second result do not match, to trigger an alarm.

Example 3 is a security controller of example 1 or 2, wherein the second operation input value is a permutation of the first operation input value.

Example 4 is a security controller of example 2, wherein the permutation is a rotation.

Example 5 is a security controller of example 3 or 4, wherein the third operation compensates that the second operation input value is a permutation with respect to the first operation input value.

Example 6 is a security controller of any one of examples 3 to 5, wherein the second operation compensates that the second operation input value is a permutation of the first operation input value or the security controller is configured to decompose the selection value in a manner such that the second share includes a permutation to compensate that the second operation input value is a permutation of the first operation input value.

Example 7 is a security controller of any one of examples 1 to 2, wherein the second operation input value and the first operation input value are equal.

Example 8 is a security controller of any one of examples 1 to 7, where one of the selection function input values is a dummy input value and the other of the selection function input values is a real data input value.

Example 9 is a security controller of any one of examples 1 to 8, wherein the selection value indicates whether a dummy operation is to be performed.

Example 10 is a security controller of any one of examples 1 to 9, wherein at least one of the first operation input value and the second operation input value is an exclusive-or combination of the two selection function input values.

Example 11 is a security controller of any one of examples 1 to 10, wherein the processor is configured to perform the first operation such that it does not operate on the second share (i.e. is independent from the second share (given the first share)).

Example 12 is a security controller of any one of examples 1 to 11, wherein the result of the second operation does not operate on the first share.

Example 13 is a security controller of any one of examples 1 to 12, wherein the first operation involves an AND combination of its inputs or where the second operation involves an AND combination of its inputs or both.

Example 14 is a security controller of any one of examples 1 to 13, wherein the processor includes an arithmetic logic unit with multiple input terminals configured to perform the first operation and the second operation, wherein the processor is configured such that the arithmetic logic unit receives the first operation input value for performing the first operation at a different input terminal than the second operation input value for performing the second operation.

Example 15 is a security controller of example 14, wherein the processor is configured such that the arithmetic logic unit receives the first share for performing the first operation at a different input terminal than the second share for performing the second operation.

Example 16 is a security controller of any one of examples 1 to 15, including a random number generator and configured to decompose the selection value into at least the first share and the second share depending on a random number provided by the random number generator.

Example 17 is a security controller of any one of examples 1 to 16, configured to decompose the selection value into the first share and the second share in such a way that an arithmetic combination of the first share and the second share or of the first share and a permuted version of the second share results in the selection value.

Example 18 is a security controller of any one of examples 1 to 17, configured to decompose the selection value into the first share and the second share such that an exclusive-or combination of the first share and the second share or of the first share and a rotated version of the second share gives the selection value.

Example 19 is a security controller of any one of examples 1 to 18, wherein the first share and the second share have the same number of bits.

Example 20 is a security controller of any one of examples 1 to 19, wherein the first share and the second share have the same number of bits as the selection value.

Example 21 is a method for performing a selection function as described above with reference to FIG. 9.

According to a further example, a processing device is provided including decomposing means for decomposing a selection value into at least a first share and a second share, wherein the selection value indicates which of two selection function input values should be selected, first processing means for means executing a first operation to generate a first operation result, wherein the first operation receives as input the first share and a first operation input value which depends on at least one of the selection function input values, second processing means for executing a second operation to generate a second operation result, wherein the second operation receives as input the second share and a second operation input value which depends on at least one of the selection function input values and third processing means for executing a third operation which processes the first operation result and the second operation result in such a way that the execution of the first operation, the second operation and the third operation implement a selection function which combines the selection function input values with the selection value such that the combination results in the one of the selection function input values for which the selection value indicates that it is to be selected.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A security controller circuit configured to decompose a selection value into at least a first share and a second share, wherein the selection value indicates which of two selection function input values should be selected; the security controller circuit comprising a processor circuit configured to:
execute a first operation to generate a first operation result, wherein the first operation receives as input the first share and a first operation input value which depends on at least one of the selection function input values;
execute a second operation to generate a second operation result, wherein the second operation receives as input the second share and a second operation input value which depends on at least one of the selection function input values; and
execute a third operation that processes the first operation result and the second operation result in such a way that the execution of the first operation, the second operation and the third operation implement a selection function which combines the selection function input values with the selection value such that the combination results in the one of the selection function input values for which the selection value indicates that it is to be selected.

2. The security controller circuit of claim 1, wherein the processor circuit is configured to calculate a first result based on the first operation result, the second operation result and/or the result of the third operation, and the security controller circuit comprises a further processor circuit configured to calculate a second result by applying the selection function to the first selection function input value and the second selection function input value, and wherein the security controller circuit is configured to check whether the first result and the second result match and, if the first result and the second result do not match, to trigger an alarm.

3. The security controller circuit of claim 2, wherein the permutation is a rotation.

4. The security controller circuit of claim 1, wherein the second operation input value is a permutation of the first operation input value.

5. The security controller circuit of claim 4, wherein the third operation compensates that the second operation input value is a permutation with respect to the first operation input value.

6. The security controller circuit of claim 4, wherein the second operation compensates that the second operation input value is a permutation of the first operation input value or the security controller is configured to decompose the selection value in a manner such that the second share includes a permutation to compensate that the second operation input value is a permutation of the first operation input value.

7. The security controller circuit of claim 1, wherein the second operation input value and the first operation input value are equal.

8. The security controller circuit of claim 1, where one of the selection function input values is a dummy input value and the other of the selection function input values is a real data input value.

9. The security controller circuit of claim 1, wherein the selection value indicates whether a dummy operation is to be performed.

10. The security controller circuit of claim 1, wherein at least one of the first operation input value and the second operation input value is an exclusive-or combination of the two selection function input values.

11. The security controller circuit of claim 1, wherein the processor is configured to perform the first operation such that it does not operate on the second share.

12. The security controller circuit of claim 1, wherein the result of the second operation does not operate on the first share.

13. The security controller circuit of claim 1, wherein the first operation involves an AND combination of its inputs or where the second operation involves an AND combination of its inputs or both.

14. The security controller circuit of claim 1, wherein the processor circuit comprises an arithmetic logic unit with multiple input terminals configured to perform the first operation and the second operation, and wherein the processor circuit is configured such that the arithmetic logic unit receives the first operation input value for performing the first operation at a different input terminal than the second operation input value for performing the second operation.

15. The security controller circuit of claim 14, wherein the processor circuit is configured such that the arithmetic logic unit receives the first share for performing the first operation at a different input terminal than the second share for performing the second operation.

16. The security controller circuit of claim 1, comprising a random number generator and configured to decompose the selection value into at least the first share and the second share depending on a random number provided by the random number generator.

17. The security controller circuit of claim 1, wherein the security controller circuit is configured to decompose the selection value into the first share and the second share in such a way that an arithmetic combination of the first share and the second share or of the first share and a permuted version of the second share results in the selection value.

18. The security controller circuit of claim 1, wherein the security controller circuit is configured to decompose the selection value into the first share and the second share such that an exclusive-or combination of the first share and the second share or of the first share and a rotated version of the second share gives the selection value.

19. A method for performing a selection function comprising:
decomposing a selection value into at least a first share and a second share, wherein the selection value indicates which of two selection function input values should be selected;
executing a first operation to generate a first operation result, wherein the first operation receives as input the first share and a first operation input value which depends on at least one of the selection function input values;
executing a second operation to generate a second operation result, wherein the second operation receives as input the second share and a second operation input value which depends on at least one of the selection function input values; and
executing a third operation which processes the first operation result and the second operation result in such a way that the execution of the first operation, the second operation and the third operation implement a selection function which combines the selection function input values with the selection value such that the combination results in the one of the selection function input values for which the selection value indicates that it is to be selected.
